(19) United States
(12) Patent Application Publication
(10) Pub. No.: US 2009/0279566 A1
(43) Pub. Date: Nov. 12, 2009

(54) METHOD AND SYSTEM FOR REDUCING CALL SET UP TIME IN A GROUP CALL

(75) Inventors: Vivek G. Naik, Deerfield, IL (US); Thomas B. Hart, West Dundee, IL (US); Sandeep Vig, Carpentersville, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/118,782

(22) Filed: May 12, 2008

(51) Int. Cl. H04L 12/413; H04Q 7/20

(52) U.S. Cl. 370/445; 455/458; 455/518

(57) ABSTRACT

A method and system for communicating over an access channel in a network are disclosed. The method includes receiving a request at the network device (102) from a first communication device (104), to initiate a group call. The method also includes the transmission of the control channel capsule (402) from the network device (102) to at least one communication device. The control channel capsule (402) comprises one or more pages associated with at least one communication device. The method also includes receiving access requests from the at least one communication device at the network device (102) by using access slots. These access slots are determined, based on the index value of each page in the control channel capsule (402).

### FIELD OF THE INVENTION

The present invention relates in general to mobile communication, and more specifically to reducing the call set up time in a group call.

### BACKGROUND OF THE INVENTION

Advances in communication technology have exponentially changed the modes of communication between humans. Technological developments in communication devices and communication networks have enabled users to communicate among themselves at any time or location. Examples of such communication devices include a mobile phone, a smart phone, a fixed-line phone, a pager, a computer, a laptop, and a Personal Digital Assistant (PDA). These communication devices communicate with each other with the help of communication networks such as the Internet, a Public Switched Telephone Network (PSTN), a global Telecommunications Exchange (TELEX) network, a Global System for Mobile (GSM) communication network, a Code Division Multiple Access (CDMA) network, a Local Area Network (LAN), and so forth.

With recent advances in communication technology, a new mode of voice communication, known as a group call, has gained ground. Group calls enable a user of a mobile phone to communicate with multiple users in a communication network simultaneously by using his mobile phone. Group calls can be used for a variety of purposes. For example, they can be used for business conferences, group chatting, and so forth.

A group call is made by using a mobile phone network, which is divided into paging areas. A paging area is a geographical region where the transmitting antenna of a communication network has coverage. A paging area consists of multiple sectors, with each sector being associated with an access channel. An access channel is an up link radio communication channel used by the communication devices to send their responses. An access channel has multiple access slots which are used by the communication device to send their responses. In a group call setup, when a user initiates a group call, requisite users present in the same or other sectors receive an information packet, which is sent over a paging channel. A paging channel is a down link radio communication channel that is used to broadcast information packets over a paging area. After receiving the information packet, each of the users tries to respond in the next available access slot in their corresponding access channel, to establish the group call. In a distributed set up, i.e., when the users are located in different sectors or in different locations of the same sector, each of the users receives the information packet at a different time. Due to this time difference in receiving the information packet, the responses are distributed over a period of time and a collision between received responses is avoided while a group call is set up. Collisions happen when more than one user tries to respond in the same access slots on the access channel. When this occurs the responses may collide with each other and their transmission may fail.

In a typical group call setup, multiple group members are usually present in vicinity to each other in the area covered by a single sector. For example, a group of factory workers are present in the same sector. These group members receive the information packet at almost the same time, due to their similar distance from the transmitting antenna. After receiving the information packet, they all try to respond almost simultaneously in the next available access slot on the access channel of the same sector, which results in collisions between the received responses. At the most, only one access request can be acknowledged, while the other requests are not. Users who do not get an access slot try again after a specific period of time. This may again result in further collisions and users may continue trying to get an access slot till the last member is able to successfully transmit and receive an acknowledgement. This causes delay in the call set up time of group calls.

Hence, in light of the above, there is a need for a method and system that reduces the number of collisions when multiple users in a group are in close proximity to each other in the same sector.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary environment, where various embodiments of the present invention can be practiced;

FIG. 2 illustrates a block diagram of a nine-sector paging area, in accordance with an embodiment of the present invention;

FIG. 3 illustrates a block diagram of collisions while accessing the access channel as per the method of prior art;

FIG. 4 illustrates a block diagram detailing the generation and ordering of pages in a control channel capsule, in accordance with an embodiment of the present invention;

FIG. 5 illustrates a block diagram of access slot distribution, in accordance with an embodiment of the present invention;

FIG. 6 illustrates a block diagram detailing the generation and ordering of pages in two control channel capsules, in accordance with an embodiment of the present invention;

FIG. 7 illustrates various elements of a communication device, in accordance with an embodiment of the present invention;

FIG. 8 illustrates a flow diagram of a method for setting up a group call, in accordance with an embodiment of the present invention; and

FIGS. 9 and 10 illustrate a flow diagram of a method for setting up a group call, in accordance with another embodiment of the present invention.

Skilled artisans will appreciate that elements in the figures have been illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

In one embodiment, a method for communicating over an access channel in a network is provided. The access channel includes one or more access slots and the network includes a network device and a plurality of communication devices. The method includes receiving a request to initiate a group call at the network device from a first communication device of the plurality of communication devices. Further, the method includes transmitting a control channel capsule from the network device to at least one communication device of the plurality of communication devices. The control channel capsule comprises one or more pages that are associated with the at least one communication device. Furthermore, the method includes receiving requests from the at least one communication device at the network device by using the access slots of the one or more access slots. These access slots are determined, based on an index value of each page of the one or more pages of the control channel capsule.

In another embodiment, a method for communicating over an access channel in a network is provided. The access channel comprises one or more access slots and the network a network device and a plurality of communication devices. The method includes receiving a request at the network device from a first communication device of the plurality of communication devices, to initiate a group call. Further, the method includes transmitting one or more control channel capsules from the network device to at least one communication device of the plurality of communication devices. The one or more control channel capsules comprise one or more pages that are associated with the at least one communication device. Furthermore, the method includes receiving requests from the at least one communication device at the network device by using the access slots of the one or more access slots.

For In another embodiment, a method for communicating over an access channel in a network is provided. The access channel includes one or more access slots and the network includes a network device and a plurality of communication devices. The method includes receiving a control channel capsule at a communication device of the plurality of communication devices from the network device. The control channel capsule comprises one or more pages that are associated with the communication devices. Further, the method includes determining an access slot at the communication device, based on the index value of the page in the control channel capsule. Furthermore, the method includes transmitting a request from the communication device to the network device by using the determined access slot.

In another embodiment, a communication device is provided. The communication device includes a receiver that is configured to receive a control channel capsule from a network device. This control channel capsule comprises one or more pages. The control channel capsule also comprises a page that is associated with the communication device. Further, the communication device includes a processor that is configured to determine an access slot, based on the index value of the page in the control channel capsule. Furthermore, the communication device includes a transmitter that is configured to transmit a request to the network device by using the determined access slot.

In yet another embodiment, a communication network is provided. The communication network includes a network device. This network device is configured to generate one or more control channel capsules, based on requests from a plurality of communication devices. Each of the one or more control channel capsules comprises one or more pages that are associated with one or more services. Further, the network device is configured to order each page in each of the one or more control channel capsules, based on the service that triggers each page.

Before describing in detail the particular method and system for communicating in a network in accordance with various embodiments of the present invention, it should be observed that the present invention utilizes a combination of method steps and apparatus components related to the method and system for communicating in a network. Accordingly, the apparatus components and method steps have been represented where appropriate by conventional symbols in the drawings, showing only those specific details that are pertinent for an understanding of the present invention, so as not to obscure the disclosure with details that will be readily apparent to those with ordinary skill in the art, having the benefit of the description herein.

In this document, relational terms such as first, second, and the like, may be solely used to distinguish one entity or action from another, without necessarily requiring or implying any actual relationship or order between such entities or actions. The terms ‘comprises,’ ‘comprising,’ ‘includes,’ ‘including,’ or any other variation thereof, are intended to cover a non-exclusive inclusion, such that a process, method, article, system or apparatus that comprises a list of elements does not include only those elements but may include other elements not expressly listed or inherent to such a process, article or apparatus. An element proceeded by ‘comprises . . . a’ does not, without more constraints, preclude the existence of additional identical elements in the process, method, article or apparatus that comprises the element. The terms ‘includes’ and/or ‘having’, as used herein, are defined as comprising.

The term ‘another,’ as used in this document, is defined as at least a second or more. The term ‘includes’ as used herein, are defined as comprising.

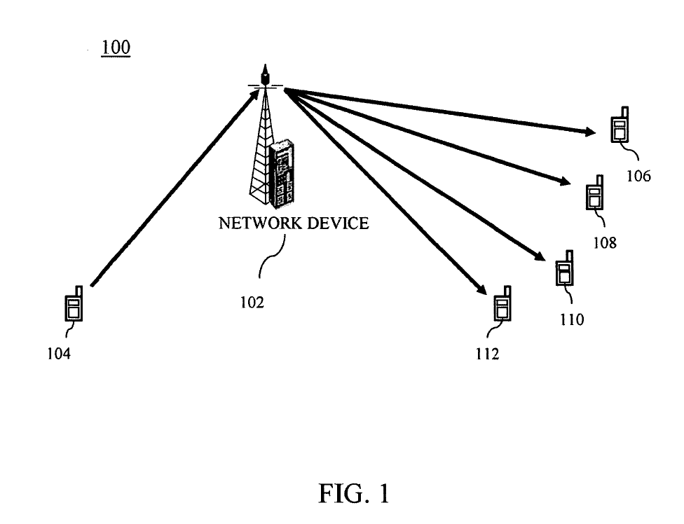

FIG. 1 illustrates an exemplary environment 100, wherein various embodiments of the present invention can be practiced. The environment 100 includes a network device 102, and one or more communication devices such as communication devices 104, 106, 108, 110 and 112. The network device 102 facilitates wireless communication between communication devices 104, 106, 108, 110 and 112 in the network. Examples of the network device 102 include, but are not limited to, Base Transceiver Station (BTS), Base Station (BS), and Radio Base Station (RBS). Examples of the communication devices 104, 106, 108, 110 and 112 include, but are not limited to, laptops, mobile phone, POC phones, Personal Digital Assistants (PDAs) and smart phones. Although only the network device 102 and the communication devices 104, 106, 108, 110 and 112 have been shown in the exemplary environment 100, it will be apparent to a person ordinarily skilled in the art that the environment 100 can include more or less than the number of network and communication devices shown.

Each communication device, for example, 104, 106, 108, 110 and 112, is capable of initiating a group call. For example, let us consider communication device 104, which initiates a group call by sending a group call initiation request to the network device 102. On receiving the group call initiation request, the network device 102 generates page packets that are associated with each terminating communication device of the group call. For example, if communication devices 106, 108, 110 and 112 are the four terminating communication devices in the group call, four pages are generated by the network device 102, where each page is associated with the communication devices 106, 108, 110 and 112. These page packets are encapsulated in a control channel capsule, which is sent over a paging area over a paging channel.

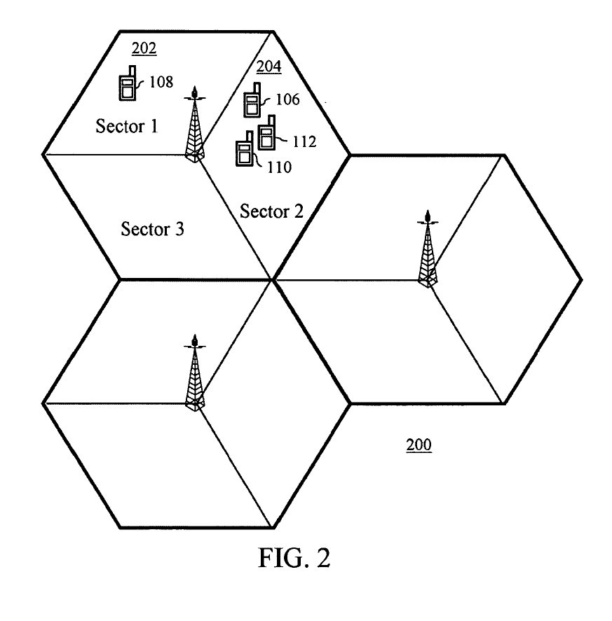

FIG. 2 illustrates a block diagram of a nine-sector paging area 200, in accordance with an embodiment of the present invention. As mentioned in FIG. 1, a paging area is divided into multiple paging sectors. For example, the paging area 200 is a nine-sector paging area. FIG. 2 also illustrates the location of communication devices 108, 106, 110 and 112 in the paging area 200. The communication device 108 is located in sector-1 202 of the paging area 200. The communication devices 106, 110 and 112 are located in the sector-2 204 of the paging area 200. Each communication device in the communication network can originate an event of communication. A single origination event generates pages that are associated with related communication devices. For one embodiment, the origination event can include a group call initiation request. For another embodiment, the origination event can include a regular call request or an email request sent by a communication device.

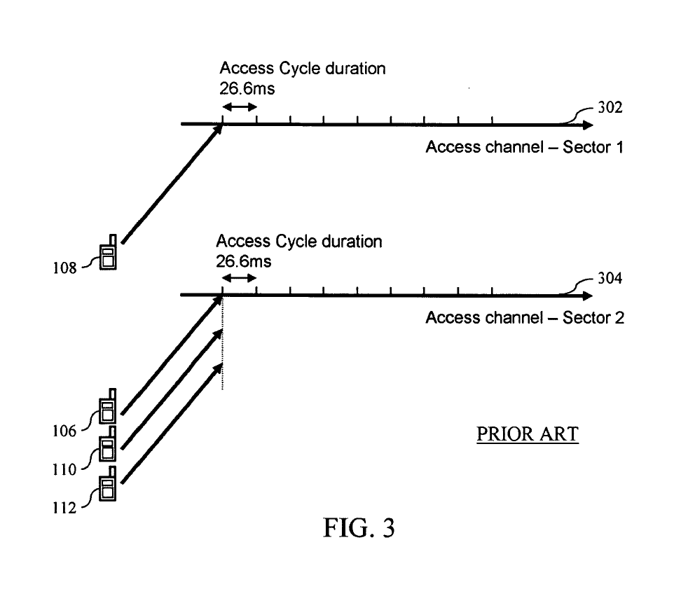

FIG. 3 illustrates a block diagram of collisions while accessing the access channel as per the method of prior art. The access channel 302 is associated with sector-1 202 and the access channel 304 with sector-2 204.

In one embodiment, in a group call, the users are present in close proximity to each other. When a group call is originated by a communication device multiple pages are generated, where each page is associated with a communication device of the group call. These pages are encapsulated in a control channel capsule that is sent to all group members at the same time. Each communication device responds only in the access slot on the access channel of the respective sector in which the communication device is present. Since the communication device 108 is present in sector-1 202, it responds in the access slot available on the access channel 302. Similarly, the communication devices 106, 110 and 112 present in sector-2 204 respond in the access slots available on the access channel 304.

The control channel capsule is sent to all four communication devices as a part of the group call. In a typical group call set up, multiple group members are generally present in close proximity to each other in the area covered by a single sector. As a result, these group members receive the same control channel capsule by using their communication devices at almost the same time due to their distance from the transmitting antenna being almost the same. These communication devices try to respond in the next available access slot in response to the control channel capsule. For example, the communication device 108 responds in the first available access slot on the access channel 302. The communication devices 106, 110 and 112 try to respond simultaneously in the first available access slot on the access channel 304. As a result, there are multiple collisions between the received responses. At most, only one access request may be acknowledged while the other two requests are not. The communication devices that are not acknowledged, attempt another access after a fixed period of time. In general, the period of time for another attempt is 250 ms. This attempt for access by multiple communication devices may again result in a collision. Thus, the process continues until all access attempts are acknowledged. Due to these multiple attempts and collisions, setting up a group call takes a considerable amount of time.

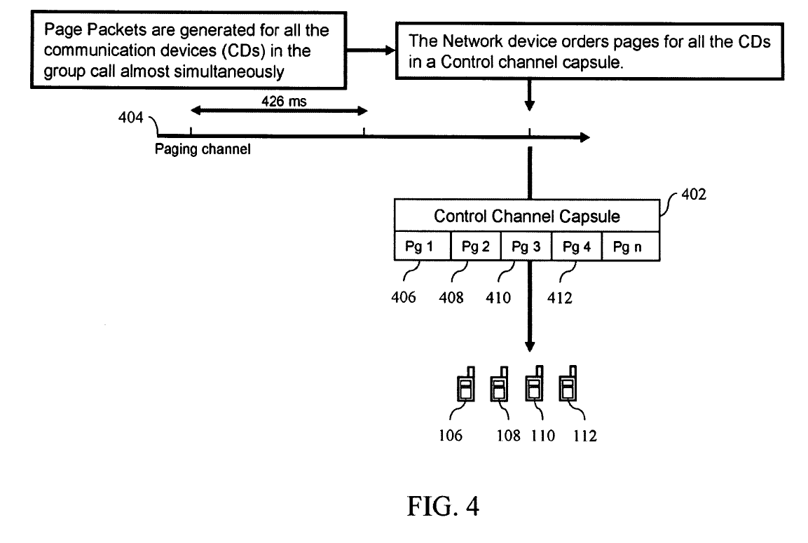

FIG. 4 illustrates a block diagram detailing the generation and ordering of pages in the control channel capsule 402, in accordance with an embodiment of the present invention. Page messages associated with communication devices 106, 108, 110 and 112 are generated in response to a group call initiation request from the communication device 104. The generated page messages are then sent in the control channel capsule 402 to each communication device. The control channel capsule 402 comprises multiple pages, where each page is associated with a communication device. For example, page one 406, page two 408, page three 410 and page four 412 in the control channel capsule 402 correspond to the communication devices 106, 108, 110 and 112, respectively. The pages in the control channel capsule 402 are arranged by the network device 102 in the Access Network (AN). The AN is used for communication between the network device 102 and communication devices 104, 106, 108, 110 and 112.

In one embodiment, the pages are arranged based on the service triggering the page. The service, may, for example, include a group call, a web-browsing activity and streaming etc. In another embodiment, the pages in the control channel capsule 402 are ordered based on the call set up time of the service triggering each page. For example, assume that there are M pages in the control channel capsule 402, of which N pages are associated with group calls. The network device 102 arranges the pages associated with the group calls first, i.e., from the first through the N^{th} page, followed by the pages for the other services that are placed next, i.e., from N+1 through M. Other services include regular calls, web-browsing activities, emails, streaming, etc. In yet another embodiment of the present invention, pages associated with emergency calls are placed first, to give them a priority over the other services. The communication devices 106, 108, 110 and 112 receive the control channel capsule 402 that is sent over the paging channel 404. These communication devices monitor the paging channel 404 after a fixed period of time for any new control channel capsule. In general, the fixed period of time is 426 ms.

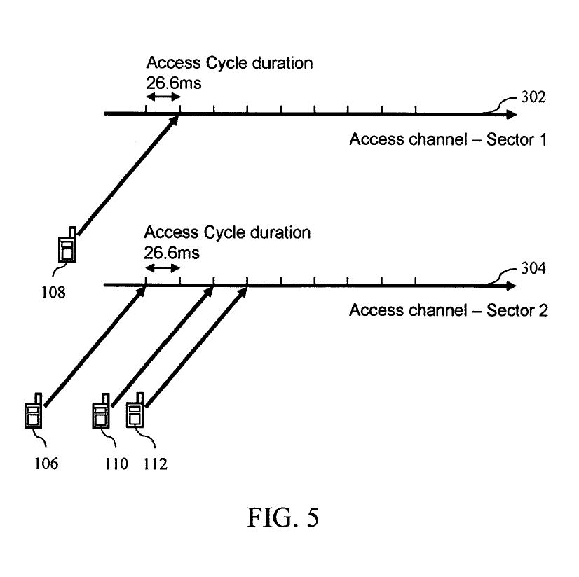

FIG. 5 illustrates a block diagram of access slot distribution, in accordance with an embodiment of the present invention. The access channel 302 is associated with the sector-1 202 and the access channel 304 with sector-2 204. Since the communication device 108 is present in the sector-1 202, it tries to respond in the slot available on the access channel 302. Similarly, the communication devices 106, 110 and 112 present in the sector-2 204 try to respond in the access slots available on the access channel 304. The control channel capsule 402 containing pages associated with the communication devices 106, 108, 110 and 112, is generated in response to an origination event. In one embodiment, the origination event is, for example, the initiation of a group call by a communication device. In another embodiment, the origination event is, for example, a web-browsing request sent by a communication device. In yet another embodiment, the origination event is, for example, the initiation of a regular call by a communication device. A regular call is a one-to-one call between two subscribers.

Each page in the control channel capsule 402 is associated with a communication device. The communication devices, on receiving the control channel capsule 402, attempt to respond in the access slot that corresponds to the index of the page message associated with the respective communication device. For example, the control channel capsule 402 comprises pages that are stored in the order of communication devices 106, 108, 110 and 112. When these communication devices receive the control channel capsule 402, each device checks for the presence of multiple pages in the capsule. Upon detecting multiple pages present in the control channel capsule 402, each communication device determines the index of its page message in the control channel capsule 402. This index value is stored as the “Page_index” in the memory of the communication device for future processing. The communication device adds an access delay of requisite access slot units, based on the page index. For example, if the index value of the communication device 112 in the control channel capsule 402 is 4, it adds a delay of [(4−1)*26.6] ms, i.e., 106.4 ms on the access slot, which corresponds with the fourth access slot on the access channel 304.

In a similar manner, the communication device 106 that is first in the order, by its index value in the control channel capsule 402, responds in the first slot on the access channel 304. The communication device 108 responds in the second access slot on the access channel 302. This method spreads these access attempts across multiple access slots, as all communication devices respond in different access slots. This results in the elimination of collisions in a group call set up, thereby reducing the call set up time.

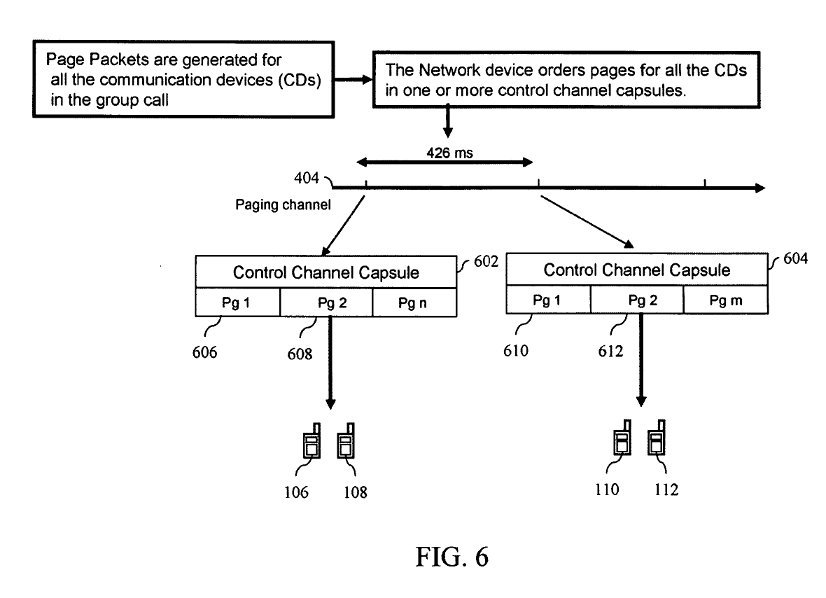

FIG. 6 illustrates a block diagram detailing the generation and ordering of pages in two control channel capsules 602 and 604, in accordance with an embodiment of the present invention. Page messages associated with communication devices 106, 108, 110 and 112 are generated in response to a group call initiation request from the communication device 104. Each control channel capsule comprises multiple pages, where each page is associated with a communication device. For example, page one 606 and page two 608 in the control channel capsule 602 correspond to the communication devices 106 and 108 respectively. Similarly page one 610 and page two 612 in the control channel capsule 604 correspond to the communication devices 110 and 112 respectively. The pages in the control channel capsules 602 and 604 are distributed and arranged by the network device 102 in the Access Network (AN). Further, the network device 102 sends the control channel capsules 602 and 604 over the paging channel 404, separated by a fixed time difference. In general, the fixed period of time is 426 ms. The control channel capsule 604 is sent after sending the control channel capsule 602. As a result, the communication devices 106 and 108 which are associated with the control channel capsule 602, respond before the communication devices 110 and 112 which are associated with the control channel capsule 604. This difference in response time of the communication devices prevents the collision amongst the sent responses.

In one embodiment, the network device 102 distributes the pages associated with the group calls in multiple control channel capsules when the maximum page carrying limit of a control channel capsule is reached. Maximum page carrying limit is the maximum number of pages that can be encapsulated in a control channel capsule. In another embodiment, the pages are encapsulated in multiple control channel capsules when the terminating communication devices are not configured for determining the access slot based on the index value of the page in a control channel capsule. In such a case, the distribution of the pages across multiple control channel capsule avoids the collisions by distributing the access slot in the access channel in which the communication devices respond.

The network devices 102 are configured to determine how the pages associated with the group call are sent. The network device 102 can use a single control channel capsule or multiple control channel capsule based upon the requirements of avoiding collisions.

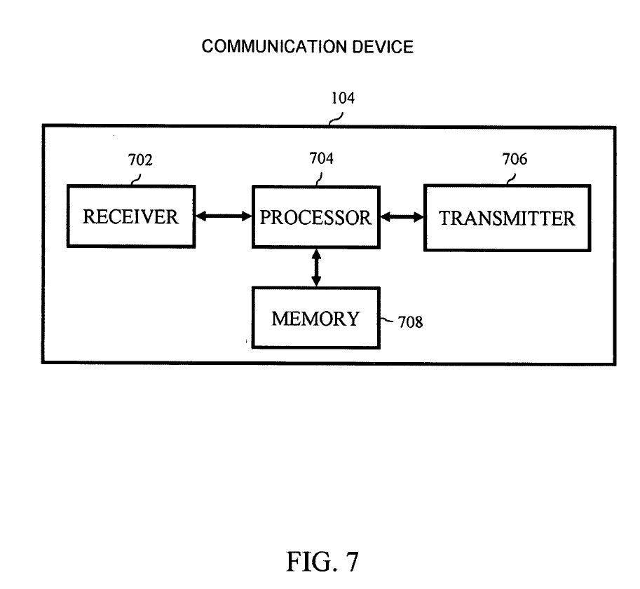

FIG. 7 illustrates various elements of the communication device 104, in accordance with an embodiment of the present invention. In one embodiment, the communication device 104 can include a receiver 702, a processor 704, a transmitter 706, and a memory 708.

The receiver 702 is configured to receive the control channel capsule 402 from the network device 102. The control channel capsule 402 includes pages associated with the communication devices. For example, page one 406, page two 408, page three 410 and page four 412 in the control channel capsule 402 correspond to the communication devices 106, 108, 110 and 112, respectively. Once the control channel capsule 402 is received by the receiver 702, the processor 704 determines whether multiple group pages are present in the control channel capsule 402. Further, the processor 704 determines an access slot in response to the control channel capsule 402 received by the receiver 702. In one embodiment, access slot determination is based on the index value of the page in the control channel capsule 402. The index values of the pages correspond to the order of the page associated with the communication device in the control channel capsule 402. For example, assume there are four pages in the control channel capsule 402 that correspond to the index values of 1, 2, 3 and 4. The communication device 104 is associated with the page that has an index value of 1. The processor 704 determines the first access slot on the access channel to respond to the received control channel capsule 402. In another example, if the communication device 104 is associated with the page that has an index value of 2, the processor 704 adds an access delay of one slot unit on the access slot, such that the communication device 104 responds in the second access slot. In this way, the communication device 104 adds a suitable access delay on the access slot. This access slot delay is added in a manner such that each communication device responds in a different access slot, thereby reducing collisions.

The transmitter 706 is configured to transmit a request to the network device 102 by using the access slot determined by the processor 704. The request is sent in response to the control channel capsule 402 received by the receiver 702.

The memory 708 is configured to store the index value for future processing. When the communication devices receive the control channel capsule 402, each device checks for the presence of multiple pages in the capsule, where each page is associated with a communication device. Upon detecting multiple pages present in the control channel capsule 402, each communication device determines the index of its page message in the control channel capsule 402. This index value is stored as the “Page_index” in the memory of the communication device for future processing. The communication device adds the access delay of requisite access slot units, based on the page index.

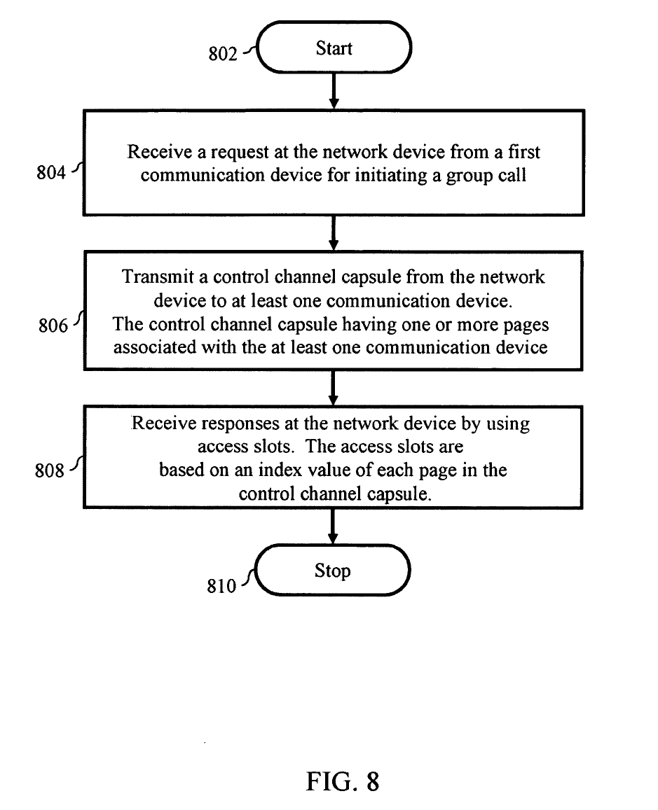

FIG. 8 is a flow diagram illustrating a method for setting up a group call, in accordance with an embodiment of the present invention. The method is initiated at step 802. A user of the communication device 104 sends a request to initiate a group call. At step 804, the request sent by the communication device 104 is received by the network device 102. Upon receiving the request, the network device 102 generates the page packets associated with each terminating communication device of the group call. For example, if communication devices 106, 108, 110 and 112 are the four terminating communication devices in the group call, four pages are generated by the network device 102, where each page is associated with the communication devices 106, 108, 110 and 112. At step 806, the network device 102 transmits the control channel capsule 402 over the paging area 200 over the paging channel 404. The page packets in the control channel capsule 402 are ordered by the network device 102 before they are transmitted. The communication devices 106, 108, 110 and 112 receive the control channel capsule 402 that is sent over the paging channel 404. These communication devices monitor the paging channel 404 after a fixed period of time for any new control channel capsules. In general, the fixed period of time is 426 ms. After decoding the contents of the control channel capsule 402, each communication device attempts to respond in the access channel slot on the access channel of the respective sector in which the communication device is present.

In one embodiment, the pages associated with the four terminating communication devices 106, 108, 110 and 112 are encapsulated in one or more control channel capsules. For example, each of the control channel capsules 602 and 604 has pages associated with one or more communication devices 106, 108, 110 and 112. For example, page one 606 and page two 608 in the control channel capsule 602 correspond to the communication devices 106 and 108 respectively. Similarly page one 610 and page two 612 in the control channel capsule 604 correspond to the communication devices 110 and 112 respectively. The communication devices 106, 108, 110 and 112 receive the control channel capsules 602 and 604 that are sent over the paging channel 404. The control channel capsules 602 and 604 are sent over the paging channel 404, separated by a fixed time difference. The control channel capsule 604 is sent after sending the control channel capsule 602.

At step 808, the network device 102 receives the responses of the communication devices. These responses are sent by the communication devices in the access channel slot on the access channel in the respective sectors. Access channel slot determination is based on the index value of the page associated with the communication device in the control channel capsule 402. For example, assume that there are four pages in the control channel capsule 402 that correspond to the index values of 1, 2, 3 and 4. The communication device associated with the page that has an index value of 1 responds in the first access slot on the access channel. The communication device associated with the page with an index value of 2 adds an access delay of one slot unit on the access slot and thus responds in the second access slot. In this way, each communication device adds a suitable access delay on the access slot. The access slot delay is added in a manner such that each communication device responds in a different access slot, thereby reducing collisions.

In another example, the network device 102 generates two control channel capsules 602 and 604. The communication devices 106 and 108 which receive the control channel capsule 602, respond before the communication devices 110 and 112, which receive the control channel capsule 604. The difference in response times of communication devices due to pages encapsulated in more than one control channel capsule reduces the number of collisions amongst responses. The method is terminated at step 810.

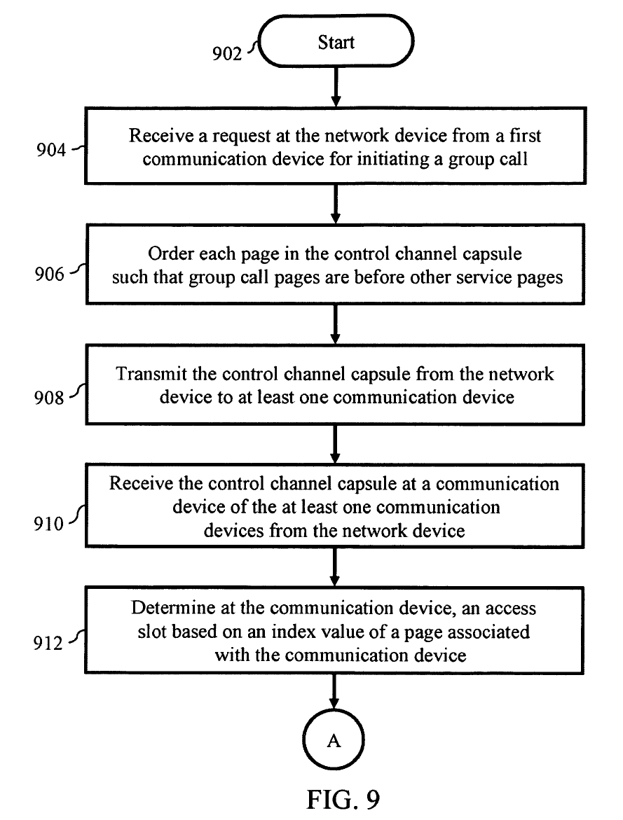

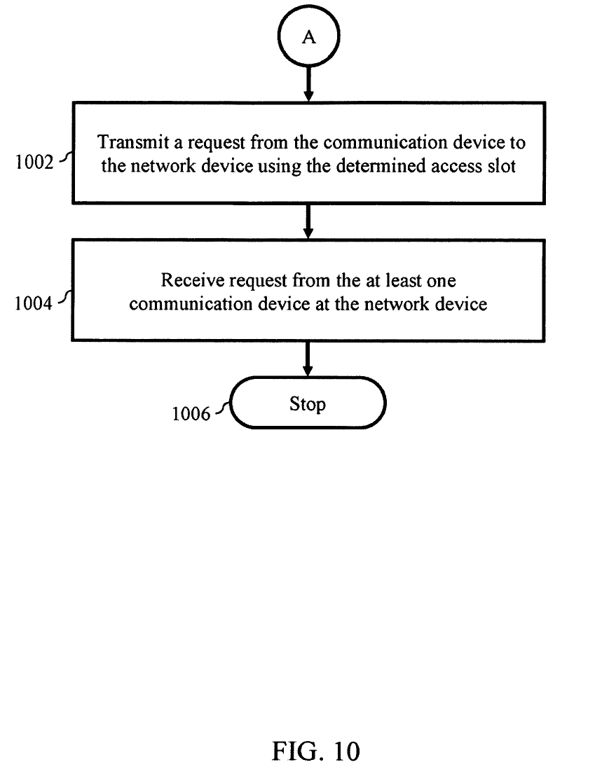

FIGS. 9 and 10 are a flow diagram illustrating a method for setting up a group call, in accordance with another embodiment of the present invention. The method is initiated at step 902. A user of the communication device 104 sends a request to the network device 102 to initiate a group call. At step 904, the request sent by the communication device 104 is received by the network device 102, which then generates page packets associated with each terminating communication device of the group call.

At step 906, the page packets are encapsulated in the control channel capsule 402. In one embodiment, the control channel capsule 402 contains multiple pages that are related to a group call and other services such as web-browsing, streaming, emails, etc. In this case, the pages are arranged, based on the service triggering the page. The service, for example, may include a group call, a web-browsing activity, emails, streaming, etc., based on a predefined preference order. In another embodiment, the pages in the control channel capsule 402 are ordered, based on the call set up time of the service triggering each page. In yet another embodiment of the present invention, if there are N group call pages, these are arranged in the first through the Nth position of the control channel capsule 402.

At step 908, the control channel capsule 402 containing the ordered pages is transmitted over the paging channel 404 over the paging area 200 to at least one communication device. At step 910, the communication devices receive the control channel capsule 402. For example, the communication devices 106, 108, 110 and 112 receive the control channel capsule 402 that is transmitted over the paging channel 404.

At step 912, each communication device determines the access channel slot to respond in based on the index value of the page associated with the communication device in the control channel capsule 402. For example, assume there are four pages in the control channel capsule 402 that correspond to the index values of 1, 2, 3 and 4. The communication device associated with the page with an index value of 1 determines the first access slot to respond in on the access channel. Similarly, the communication device associated with the page that has an index value of 2 adds an access delay of one slot unit on the access slot, and thus responds in the second access slot. In this way, each communication device adds a suitable access delay on the access slot. The access slot delay is added in a manner such that each communication device responds in a different access slot.

At step 1002, each communication device sends a response to the network device 102 in the access slot determined at step 912. At step 1004, the network device 102 receives the response sent by each communication device. After receiving the responses of all the communication devices associated with the group call, the group call is set up. Since each communication device sends a response in a different access slot, there are no collisions while setting up a group call. The method is terminated at step 1006.

Various embodiments of the present invention offer one or more advantages. The present invention provides a method and system for reducing the call set up time in a group call. The present invention ensures that there are no collisions while setting up a group call, especially when multiple communication devices are present in the vicinity. Consequently, the present invention ensures that the call set up time in a group call is reduced significantly. Further, the present invention ensures that access priority can be defined, based on the services triggering the call request. Moreover, the present invention ensures that group calls are given priority over the services in which the call set up time is not as critical as in a group call.

It will be appreciated that the embodiments of the invention described herein may comprise one or more conventional processors and unique stored program instructions that control the one or more processors, to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method for reducing the call setup time in a group call. Alternatively, some or all the functions could be implemented by a state machine that has no stored program instructions, or in one or more application-specific integrated circuits (ASICs), in which each function or some combinations of certain of the functions are implemented as custom logic. Of course, a combination of these approaches could be used. Thus, methods and means for these functions have been described herein. In situations where the functions of the embodiments of the invention can be implemented by using a processor and stored program instructions, it will be appreciated that one means for implementing such functions is the media that stores the stored program instructions, be it magnetic storage or a signal conveying a file. Further, it is expected that one with ordinary skill, notwithstanding possibly significant effort and many design choices motivated by, for example, available time, current technology and economic considerations, when guided by the concepts and principles disclosed herein, will be readily capable of generating such stored program instructions and ICs with minimal experimentation.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all the equivalents of those claims, as issued.

The Abstract of the Disclosure is provided to comply with 37 C.F.R. §1.72(b), which requires an abstract that will enable the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. On the contrary, as the following claims reflect, the inventive subject matter lies in less than all the features of a single disclosed embodiment. Thus, the following claims are hereby incorporated into the Detailed Description, with each claim standing on its own as a separately claimed subject matter.

What is claimed is:

1. A method for communicating over an access channel in a network, the access channel comprising one or more access slots and the network comprising a network device and a plurality of communication devices, the method comprising:
receiving a request to initiate a group call at the network device from a first communication device of the plurality of communication devices;
transmitting a control channel capsule from the network device to at least one communication device of the plurality of communication devices, the control channel capsule comprising one or more pages associated with the at least one communication device; and
receiving an access request at the network device from the at least one communication device, the request received in an access slots of the one or more access slots, wherein the access slots is determined based on an index value of a page of the one or more pages in the control channel capsule.

2. The method of claim 1 wherein before transmitting a control channel capsule, the method further comprises ordering each page in the control channel capsule based on a service triggering the each page.

3. The method of claim 2, wherein the index value of each page is determined based on the ordering of the each page in the control channel capsule.

4. The method of claim 2 wherein before transmitting a control channel capsule, the method further comprises ordering each page in the control channel capsule based on call setup time of the service triggering the each page.

5. The method of claim 4 further comprising ordering group call pages before other service pages.

6. A method for communicating over an access channel in a network, the access channel comprising one or more access slots, the network comprising a network device and a plurality of communication devices, the method comprising:
receiving a request at the network device from a first communication device of the plurality of communication devices for initiating a group call;
transmitting a plurality of control channel capsules from the network device to at least one communication device of the plurality of communication devices, the plurality of control channel capsules comprising one or more pages associated with the at least one communication device; and
receiving an access request from the at least one communication device at the network device using an access slot of the one or more access slots.

7. A method for communicating over an access channel in a network, the access channel comprising one or more access slots, the network comprising a network device and a plurality of communication devices, the method comprising:
receiving a control channel capsule at a communication device of the plurality of communication devices from the network device, wherein the control channel capsule comprises one or more pages, and wherein a page of the one or more pages is associated with the communication device;
determining at the communication device, an access slot to respond in based on an index value of the page of the one or more pages in the control channel capsule; and
transmitting an access request from the communication device to the network device using the determined access slot.

8. The method as recited in claim 7 further comprising determining the index value based on an order of the page of the one or more pages in the control channel capsule.

9. The method as recited in claim 8 further comprising storing the index value at the communication device.

10. A communication network comprising:
a network device configured to:
generate one or more control channel capsules based on requests from a plurality of communication devices, each of the one or more control channel capsules comprising one or more pages; and
order the one or more pages in each of the one or more control channel capsules based on a service triggering the one or more pages.

11. The communication network as recited in claim 10, wherein the network device is further configured to order the one or more pages in each of the one or more control channel capsules based on call setup time of the service triggering the one or more pages.

12. The communication network as recited in claim 11, wherein the network device is further configured to order group call pages before other service pages in each of the one or more control channel capsules.
